(19) United States
(12) Patent Application Publication
(10) Pub. No.: US 2020/0309380 A1
(43) Pub. Date: Oct. 1, 2020

(54) CONVECTION HEAT EXCHANGER FOR OVEN

(71) Applicant: Electrolux Home Products, Inc., Charlotte, NC (US)

(72) Inventors: Brian Martin, Nashville, TN (US); Michael Padgett, Springfield, TN (US)

(21) Appl. No.: 16/369,016

(22) Filed: Mar. 29, 2019

(51) Int. Cl. F24C 15/32; A21B 1/26

(52) U.S. Cl. CPC F24C 15/322; A21B 1/26

(57) ABSTRACT

An oven includes a gas burner provided at a rear bottom portion of the oven and below an opening in a bottom panel of the oven. A heat exchanger is provided above the bottom panel opening such that heated air from the gas burner flows upwardly through the heat exchanger. The heat exchanger is positioned in front of a fan provided at a rear wall of the oven. The fan forces air through a plurality of openings in the heat exchanger to supply heated air to an oven cavity of the oven. The gas burner flames are substantially isolated from turbulent airflow from the fan.

### BACKGROUND

### 1. Field of the Invention

The following description relates generally to a gas oven and, more specifically, to a gas burner and heat exchanger configuration for an oven.

### 2. Description of Related Art

A convection oven includes a fan, typically positioned at a rear wall of an oven cavity, and at least one heating element, such as a gas burner or electric heating element. The fan blows hot air from the heating element(s) over and around food in the oven cavity in order to cook the food more quickly and evenly than in non-convection ovens. This air is then vented out through an exhaust system. The use of a gas burner in a convection oven has been problematic as the presence of turbulent airflow from the fan affects the flame from the burner. More specifically, the fan flow turbulence has a tendency to separate the flame from its anchoring burner and to extinguish the flame, severely incapacitating the efficiency of the burner. Also, the flame must be lit or initiated when the burner is turned on. Turbulent air flow in the fan chamber affects the ignition operation and hampers flame ignition, blowing the gas away from the ignitor.

### SUMMARY

The following presents a simplified summary in order to provide a basic understanding of the embodiments described herein. This summary is not an extensive overview nor is it intended to identify key or critical elements. Its sole purpose is to present some concepts in a simplified form as a prelude to the more detailed description that is presented later.

According to one embodiment, a heat exchanger for an oven is provided. The heat exchanger includes: a housing having a top portion and a bottom portion; an inlet port formed at a bottom portion of the housing; an outlet port formed at a top portion of the housing; a plurality of conduits formed within the housing, each of the plurality of conduits extending through the housing between the inlet port and the outlet port; and a plurality of openings formed between the plurality of conduits such that airflow through the plurality of openings flows past external surfaces of the plurality of conduits.

According to another embodiment, a gas burner and heat exchanger assembly are provided. The assembly includes: a burner body having a plurality of flame ports extending through a top portion of the burner body and a heat exchanger. The heat exchanger includes: a housing with an inlet port and an outlet port, the inlet port positioned above the burner body such that flames from the flame ports extend towards the inlet port of the heat exchanger, a plurality of linear conduits extending through the housing between the inlet port and the outlet port, wherein exhaust airflow flows through the plurality of linear conduits, and a plurality of openings extending through the housing such that a direction of airflow through the plurality of openings is substantially perpendicular to a direction of the exhaust airflow through the plurality of linear conduits.

According to another embodiment, an oven is provided. The oven includes: an oven cavity having a rear wall; a fan coupled to the rear wall; a heat exchanger positioned at a rear portion of the oven cavity, the fan being positioned between the heat exchanger and the rear wall; and a gas burner positioned at the rear portion of the oven cavity, directly below the heat exchanger such that exhaust airflow from the gas burner flows upwardly into the heat exchanger.

Other features and aspects will be apparent from the following detailed description, the drawings, and the claims.

### BRIEF DESCRIPTION OF THE DRAWINGS

Throughout the drawings and the detailed description, unless otherwise described, the same drawing reference numerals can be understood to refer to the same elements, features, and structures. The relative size and depiction of these elements may be exaggerated for clarity, illustration, and convenience.

FIG. 1 is a schematic view of an oven in accordance with an embodiment.

FIG. 2 is an exploded perspective view of heat exchanger and burner assembly for an oven in accordance with an embodiment.

FIG. 3 is a front perspective view of the heat exchanger and burner assembly for an oven in an assembled state in accordance with an embodiment.

FIG. 4 is a rear perspective view of the heat exchanger and burner assembly for an oven in an assembled state in accordance with an embodiment.

FIG. 5 is a top view of a burner and bottom plate assembly for an oven in accordance with an embodiment.

FIG. 6 is an exploded perspective view of a heat exchanger for an oven in accordance with an embodiment.

FIG. 7 is a sectional top view of a heat exchanger and burner assembly for an oven in accordance with an embodiment.

FIG. 8 is a perspective view of a heat exchanger and burner assembly assembled within an oven cavity in accordance with an embodiment.

### DETAILED DESCRIPTION

Example embodiments are described and illustrated herein. These illustrated examples are not intended to be a limitation on the present embodiments. For example, one or more aspects of the system can be utilized in other embodiments and other types of appliances. Example embodiments of a burner and heat exchanger for a gas cooking appliance will be described more fully hereinafter with reference to the accompanying drawings. Such systems may, however, be embodied in many different forms and should not be construed as limited to the embodiments set forth herein. Like, but not necessarily the same, elements (also sometimes called modules) in the various figures are denoted by like reference numerals for consistency. Terms such as “first,” “second,” “front,” and “rear” are used merely to distinguish one component (or part of a component or state of a component) from another. Such terms are not intended to denote a preference or a particular orientation.

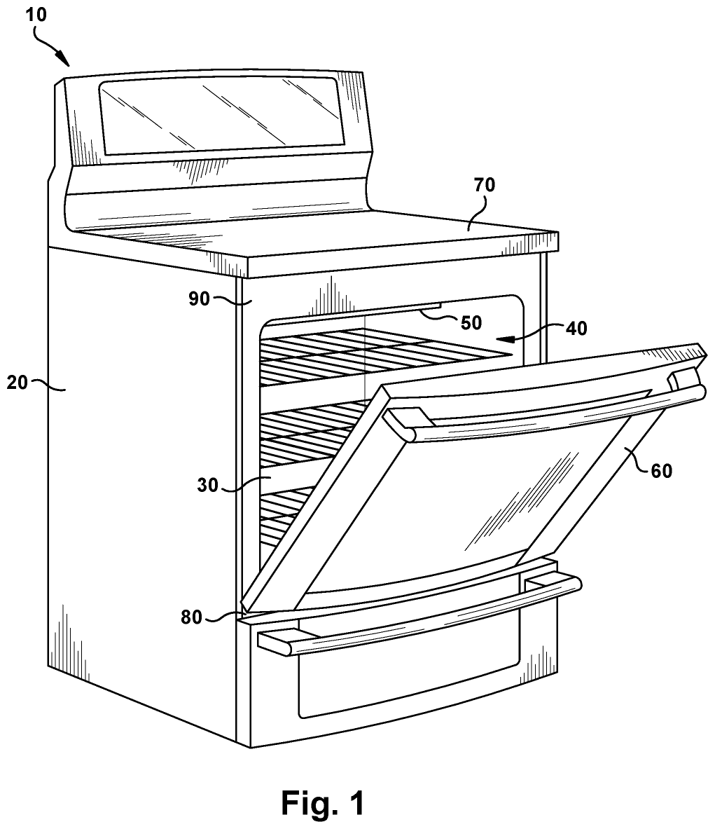

FIG. 1 shows an illustrative embodiment of a cooking appliance, such as an oven 10. The oven 10 can be built-in, wall-mounted or freestanding, although other configurations could also be used. The oven 10 includes at least a housing 20, an oven cavity 30 enclosed by the housing 20 with front opening 40, a heating element 50, and a door 60 for closing the housing 20. The cooking appliance can include both an oven 10 and a cooktop 70. However, alternate embodiments of the cooking appliance can include only an oven range 10, without the cooktop 70, and can be used in a variety of different configurations such as built-in gas ovens, etc. In addition, the oven 10 may include more than one oven cavity 30. For example, the oven 10 may include two oven cavities (a “double-cavity” configuration). A double-cavity configuration may be used in a built-in wall oven range, freestanding range, or other configurations. However, configurations are not limited thereto and more than two oven cavities may be included in other embodiments. For the sake of brevity, however, the embodiment of the cooking appliance shown in FIG. 1 will be used as an example to describe the oven door below.

As shown on FIG. 1, an oven door 60 is used to close the front of the oven cavity 30 from an outside area external to the oven range 10. The oven door 60 is pivotally mounted to the housing 20, e.g., to a lower frame 80 of the oven cavity 30. The door 60 can be pivoted around a horizontal pivot point (not shown on FIG. 1) between a horizontal position in which the front opening 40 is open for access by the user of the appliance, and a vertical position in which the front opening 40 is closed by the door 60. Alternatively, the oven door 60 may be mounted to a left side frame or a right side frame of a front panel 90 of the housing 20. In this configuration, the oven door 60 can be tilted around a vertical pivot point adjacent to a side section of the oven cavity 30. The door 60 includes a transparent section, such as a glass window in order for a user to see into the oven cavity 30 during operation of the oven without opening the door 60.

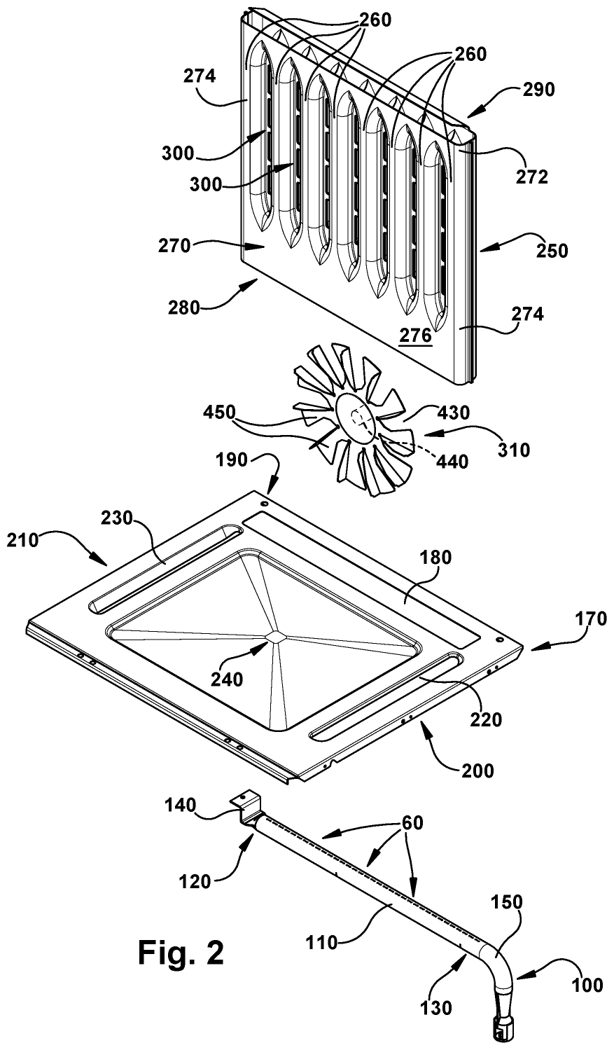

Turning now to FIG. 2, an exploded view of a gas burner and heat exchanger assembly for use in an oven, such as a convection oven, is illustrated in accordance with one embodiment. The gas burner 100 includes a body 110 having a generally tubular configuration, which forms a fuel receiving chamber therein. The burner 100 includes a first end 120 and a second end 130. The first end 120 is closed and can include a flange 140 for securing the burner 100 in place within an oven cavity. The second end 130 is open and configured to receive a corresponding tubular portion of a venturi tube 150. While the venturi tube 150 is illustrated as being bent at a 90-degree angle, a straight venturi tube or other bent venturi tube can be used in the same manner, as desired. A plurality of ports 160 are formed through a top portion of the burner body 110. The ports 160 can be of any suitable number, shape, and size as desired. When fuel is providing through the burner body 110, the fuel flows out through the ports 160 and can be ignited by a suitable ignition device (not shown) in a conventional manner. The burner 100 is positioned under a bottom panel, or bottom plate, 170 within the oven.

The bottom panel 170 can be made of an enameled sheet metal, or any other suitable material, and includes at least one opening 180 at a rear portion 190 thereof. When assembled, the at least one rear opening 180 is positioned over the burner 100 such that flames and/or heat from the gas burner 100 can pass through the rear opening(s) 180. Accordingly, the rear opening(s) 180 is of a size and shape that corresponds with the ports 160 (or with the array of ports 160) in the burner body 110. The bottom panel 170 includes first and second side portions 200, 210. At each of the first and second side portions 200, 210 is at least one opening 220, 230 provided therethrough. These first and second side openings 220, 230 provide vents between heated space under the bottom panel 170, where the gas burner 100 is housed, to a cooking space within the oven. As shown, each of the rear, first side, and second side openings 180, 220, 230 can have a single slotted configuration; however, any number of openings or configurations can be provided. A top surface of the bottom panel 170 can be downwardly sloped towards a central portion 240. Thus, any spilled food or cooking fluids can be directly toward the central portion 240 to facilitate cleaning.

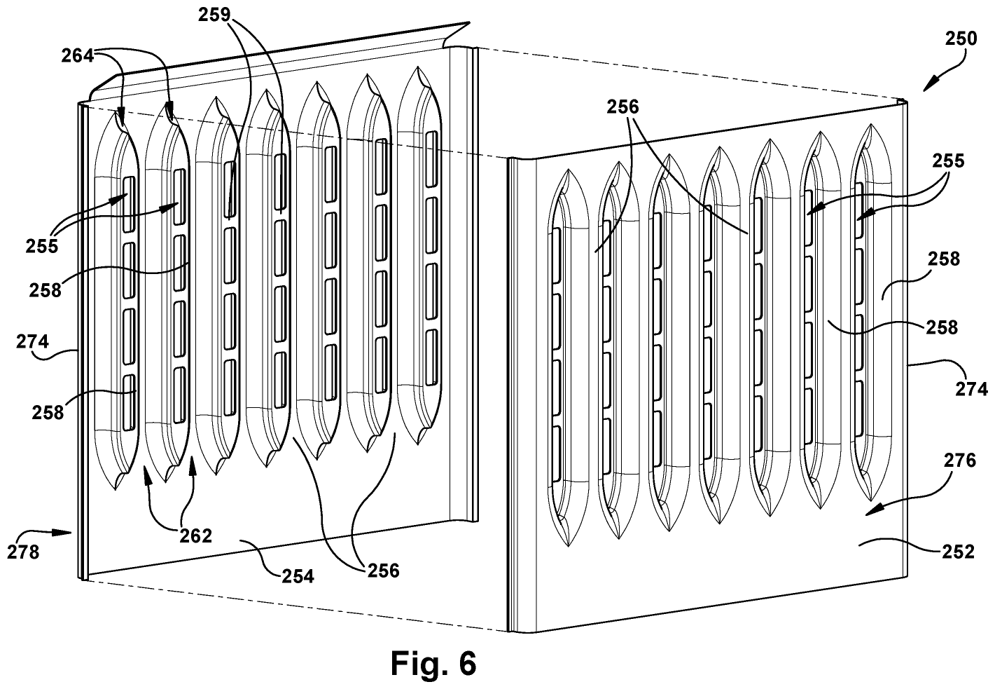

Positioned directly above the rear opening(s) 180 is heat exchanger 250. The heat exchanger 250 includes a housing that can be made from an enameled metal material, similar to the material of the bottom panel 170, and has a substantially planar expanse. The housing includes a base or bottom portion 270, a top portion 272, sides 274, a front face 276, and a rear face 278. A plurality of linear conduits or tubes 260 for carrying heated air extend through the housing. Each of the linear conduits 260 are substantially parallel to each other and include a first opening 262 (FIG. 6) at the base or bottom portion 270 of the housing and an opposite second opening 264 at the top portion 272 of the housing. The example shown includes eight linear conduits extending through the heat exchanger 250. This number may be more or less depending upon a size of the oven cavity in which the heat exchanger is employed. The bottom portion 270 of the heat exchanger 250 includes an inlet port 280 that is common or shared by each of the conduits 260. Each of the first openings 262 of the plurality of conduits 260 opens into the inlet port 280. The inlet port 280 is configured for alignment with a linear extent of the gas burner 100, or in other words, is of a shape and size such that flames exiting from the burner ports 160 can extend upward into or toward the inlet port 280 of the heat exchanger 250. Heated air is then caused to flow upward, from the inlet port 280, into and through each of the plurality of conduits 260. The heated air exits the conduits 260 at the second openings 264 to an open or common exit port 290 located at the top portion 272 of the heat exchanger 250 and finally out of the oven via the exit port 290 by natural convection.

The heat exchanger 250 is composed principally of the vertically extending conduits or tubes 260 as noted above. A plurality of openings or through ports 300 are disposed between adjacent conduits 260 and extend between the front and rear faces 276, 278 of the heat exchanger housing to provide fluid communication between a rear and a front of the heat exchanger 250. The present design shows a plurality of openings 300 between each adjacent vertically extending tube 260. However, it is to be appreciated that any number and configuration of openings can be provided through the housing and still fall within the scope of the present invention, so long as the openings 300 are configured to allow for sufficient airflow past the tubes 260. In order to facilitate this airflow, a fan 310, such as a convection fan, is positioned behind the heat exchanger 250 and more specifically, behind the plurality of tubes 260 and openings 300. Thus, air flow from the fan 310 passes between and over external surfaces of the tubes 260, exchanging heat therewith, as the air travels from behind the heat exchanger 250 and into the oven cavity. Because the tubes 260 are largely closed to this convective air flow and further because the flames from the gas burner 100 are substantially physically isolated from the convective air-flow path, there is little to no opportunity for the fan 310 to extinguish the gas flames. Accordingly, higher fan speeds are available as compared to conventional gas-convection systems where the convective air flow can pass directly over flames exiting burner-flame ports.

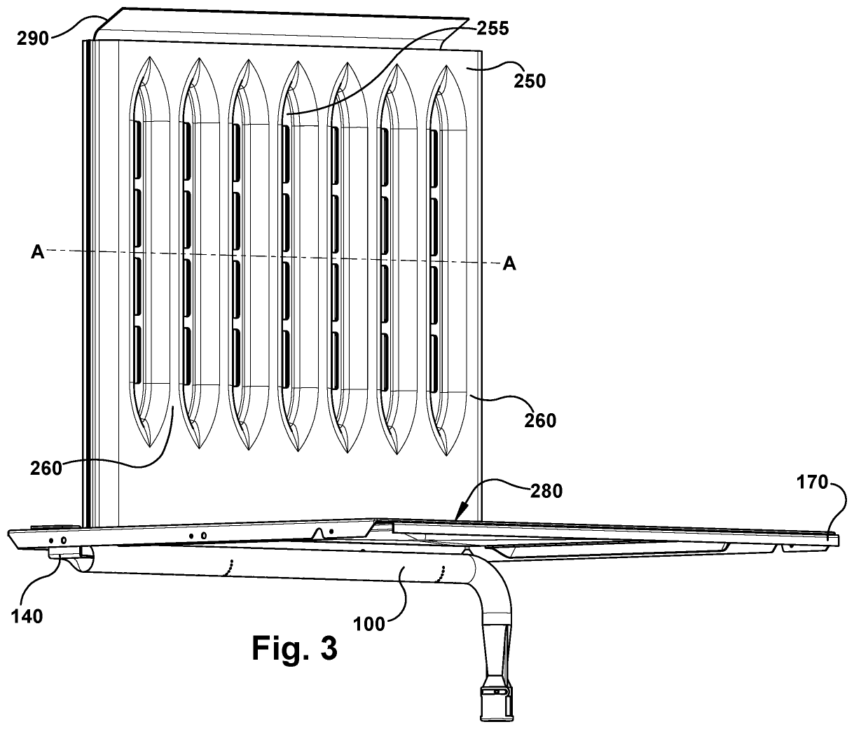

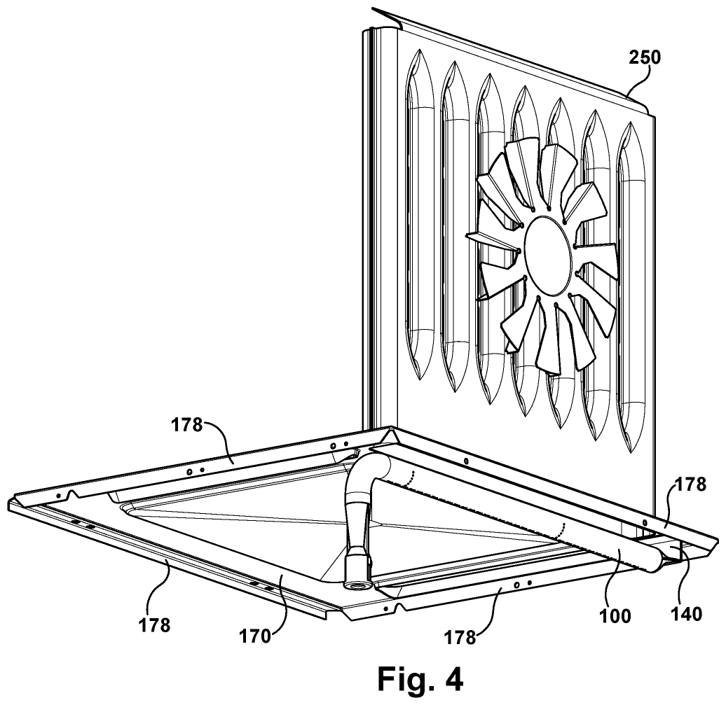

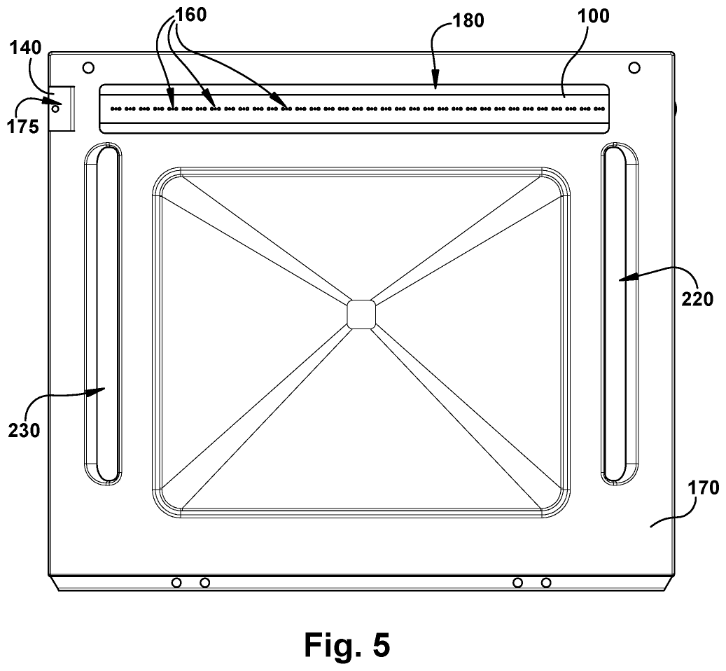

Turning now to FIGS. 3 and 4, the previously described components are shown in an assembled state. The flange 140 of the burner 100 is coupled directly to a side portion of the bottom panel 170. More specifically, the flange 140 can be an L-shaped or Z-shaped flange as shown in FIG. 2 and a first or outermost leg of the flange 140 is removably inserted into a slot 175 (See FIG. 5) provided through the bottom panel 170. The interaction of the flange 140 and the slot 175 supports the burner body 100 in position below the bottom panel 170. Additionally, or alternatively, the burner 100 can be coupled to the bottom panel 170 via conventional fasteners. It is to be appreciated that the burner 100 could be secured directly to a wall of the oven cavity, to a bracket, or to any other component within the oven, so long as the burner 100 is positioned with its flame ports 160 below the rear opening 180 of the bottom panel 170 such that the flames or heat from the flames can extend or pass through the rear opening 180. FIG. 5 illustrates a top view of the burner 100 and bottom panel 170 assembly with the heat exchanger 250 removed. As shown, each of the flame ports 160 provided through the top portion of the burner body 110 is positioned under the rear opening 180. Thus, any flames exiting the ports 160 can extend from the burner body 110 and through the rear opening 180.

Positioned directly above the rear opening 180 is the heat exchanger 250. The heat exchanger 250 can be secured directly to the bottom panel 170 or fixed in place via brackets and fasteners or the like. The inlet port 280 or the base 270 of the heat exchanger 250 substantially covers the rear opening 180 of the bottom panel 170. Accordingly, there is limited to no airflow from above the bottom panel 170 directly to the burner 100, thereby eliminating or at least minimizing any interruption or turbulent airflow to the burner flames.

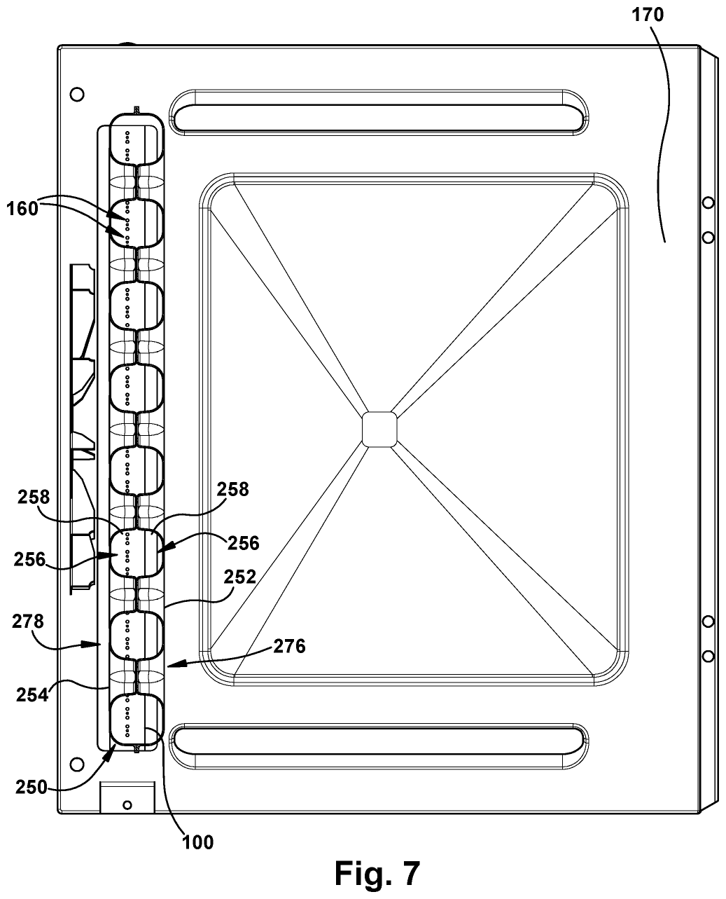

The heat exchanger 250 can be formed from two pieces of sheet metal as shown in FIG. 6. More specifically, the heat exchanger 250 comprises a first half 252 and a second half 254. An outer face of the first half 252 defines the front face 276 of the heat exchanger housing. Likewise, an outer face of the second half 254 defines the rear face 278 of the heat exchanger housing. Inner faces of the first half 252 and second half 254 include a plurality of elongated, linear troughs or channels 256 formed therein. The channels 256 of the first half 252 include sidewalls 258 that abut with corresponding sidewalls 258 in the second half 254. Between adjacent channels 256 are elongated, linear openings 255 through the first and second halves 252, 254. A length of the elongated openings 255 correspond with a length of the elongated channels 256. A plurality of strengthening ribs 259 can be provided between the channels 256 and across the openings 255 in at least one of the first and second halves 252, 254. FIG. 7 illustrates a cross sectional top view of the burner 100 and heat exchanger 250 assembly as taken through line A-A in FIG. 3. As shown, when the first and second halves 252, 254 are joined together, corresponding sidewalls 258 of corresponding channels 256 abut to form the substantially cylindrical conduits or tubes 260. Moreover, as can be seen from FIG. 7, the tubes 260 are in fluid communication with the flame ports 160 of the burner 100. Thus, air flow through the tubes 260 is heated directly by the burner 100, and preferably comprises the combustion products of the air/fuel mixture that is burned to generate flames on exiting the flame ports 160. Turning back to FIG. 3, this heated air (e.g. combustion-product mixture) flows vertically, upwardly, through the tubes 260 from the inlet port 280 to the outlet port 290. Because the base 270 of the heat exchanger housing surrounds the rear opening 180 in the bottom panel 170, the combustion products and associated heated air are contained within the heat exchanger housing until it exits the outlet port 290. Airflow from the fan 310 flows substantially horizontally through the elongated openings 255 between adjacent heated tubes 260. Accordingly, this airflow is indirectly via heat-exchange with the fluid (e.g. hot combustion products) flowing through the tubes 260 as the fan-driven airflow passes through the openings 255 between the tubes 260.

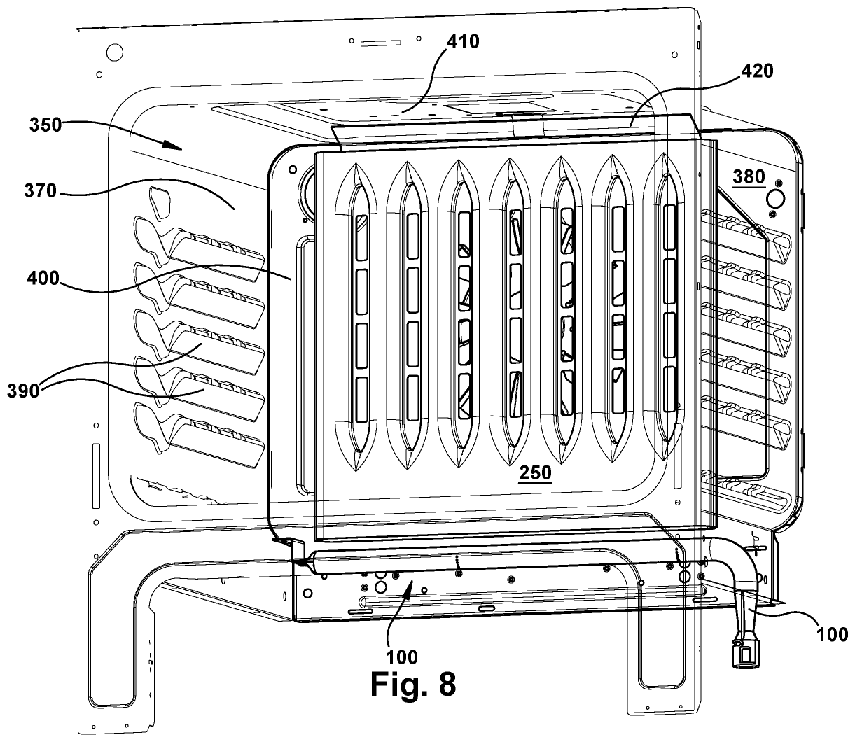

FIG. 8 illustrates the burner 100 and heat exchanger 250 assembly positioned within an oven cavity 350 of an oven. The oven cavity 350 is formed from a substantially box-like oven liner having an open front 360 that is configured to be closed by an oven door, such as door 60. The oven cavity 350 includes opposite first and second side walls 370, 380 that can be formed with or include a plurality of vertically spaced embossments or rack supports 390. A rear wall 400, a top wall 410 and a bottom wall (not shown) are also provided. The top wall 410 includes a standard oven exhaust vent (not shown) for discharging the combustion-product gases outside of the oven, or to the external atmosphere. The convection fan 310 is attached at the rear wall 400 via any suitable means. The heat exchanger 250 is positioned directly in front of the fan 310 and parallel to the rear wall 400 at a rear portion of the oven cavity 350. As shown, the heat exchanger 250 can be of a height that extends from the bottom panel 170 positioned at a bottom portion of the oven cavity 350 to the top wall 410. A forward-slanted baffle 420 can be provided at a top portion of the heat exchanger 250 and can extend a width of the heat exchanger 250 to direct the exhaust gas (combustion products) flowing through the tubes 260 to the oven exhaust vent. The width of the heat exchanger 250 is greater than a width of the fan 310 and is preferably more than half a width of the oven cavity 350, or in other words a distance between sidewalls 380, 390. Moreover, the width of the heat exchanger 250 corresponds to a length from a first flame port in the burner body 100 to a last flame port. Thus, each of the flame ports 160 can be positioned directly below the inlet port 280 of the heat exchanger 250. Accordingly, heated exhaust from the burner 100 flows vertically upwards into an interior volume of the heat exchanger 250.

The fan 310 is positioned between the heat exchanger 250 and the rear wall 400 of the oven cavity. While only a single, centrally positioned convection fan is shown and described herein, any suitable number or configuration of fans can be employed. For instance, the oven can include two side-by-side fan assemblies attached to the rear wall. As illustrated in FIG. 2, the fan 310 can be a multi-speed electric fan driven by a motor 430 having a drive shaft 440 with the fan 310 coupled to the drive shaft 440 for rotation therewith. The fan 310 comprises a plurality of blades 450 that can be curved or angled as desired. When in operation, the fan 310 blows air horizontally through openings in the heat exchanger 250 and into the oven cavity 350, in order to realize a convection-cooking cycle. In the illustrated embodiment, airflow from the fan 310 is substantially perpendicular to airflow through the conduits or tubes 260.

Although embodiments described herein are made with reference to example embodiments, it should be appreciated by those skilled in the art that various modifications are well within the scope and spirit of this disclosure. Therefore, the scope of the example embodiments is not limited herein. The disclosure is intended to include all such modifications and alterations disclosed herein or ascertainable herefrom by persons of ordinary skill in the art without undue experimentation. It will be appreciated that the burner described herein can be used in convection ranges or ovens for residential and restaurant or other commercial or industrial applications.

What is claimed is:

1. A heat exchanger for an oven comprising:
a housing having a top portion and a bottom portion;
an inlet port formed at a bottom portion of the housing;
an outlet port formed at a top portion of the housing;
a plurality of conduits formed within the housing, each of the plurality of conduits extending through the housing between the inlet port and the outlet port; and
a plurality of openings formed between the plurality of conduits such that airflow through the plurality of openings flows past external surfaces of the plurality of conduits.

2. The heat exchanger of claim 1, wherein the housing includes a front face and a rear face and wherein the plurality of openings extend through the housing from the front face to the rear face.

3. The heat exchanger of claim 2, wherein each of the plurality of openings includes at least one strengthening rib therein.

4. The heat exchanger of claim 1, wherein each of the plurality of conduits extends linearly through the housing.

5. The heat exchanger of claim 1, wherein the plurality of conduits are arranged substantially parallel to each other.

6. The heat exchanger of claim 1, further comprising a forward slanted baffle at the outlet port to direct exhaust airflow out of the housing.

7. A gas burner and heat exchanger assembly comprising:
a burner body having a plurality of flame ports in a top portion of the burner body; and
a heat exchanger comprising:
a housing with an inlet port and an outlet port, the inlet port positioned above the burner body such that flames from the flame ports extend towards the inlet port of the heat exchanger,
a plurality of linear conduits extending through the housing between the inlet port and the outlet port, wherein combustion products generated by said flames flow through the plurality of linear conduits, and
a plurality of openings extending through the housing such that a direction of airflow through the plurality of openings is substantially perpendicular to a direction of the combustion-product flow through the plurality of linear conduits.

8. The gas burner and heat exchanger assembly of claim 7, further comprising a panel extending between the burner body and the heat exchanger housing, wherein the panel includes an opening therein to provide fluid communication between the flame ports of the burner body and the inlet port of the heat exchanger housing.

9. The gas burner and heat exchanger assembly of claim 7, further comprising a fan positioned behind a rear face of the heat exchanger housing to generate said airflow, wherein said airflow from the fan travels through the plurality of openings and past external surfaces of the plurality of conduits.

10. The gas burner and heat exchanger assembly of claim 9, wherein the heat exchanger housing isolates the flame ports of the burner body from the airflow from the fan.

11. An oven comprising:
an oven cavity having a rear wall;
a convection fan adjacent to the rear wall;
a heat exchanger positioned in a rear portion of the oven cavity, the fan being positioned between the heat exchanger and the rear wall; and
a gas burner positioned directly below the heat exchanger such that combustion products generated via flames from the gas burner will flow upwardly into the heat exchanger.

12. The oven of claim 11, wherein an airflow generated by the fan will flow perpendicularly to the upward flow of said combustion products through the heat exchanger.

13. The oven of claim 11, wherein the gas burner comprises a tubular burner body having a plurality of flame ports in a top portion of the tubular burner body.

14. The oven of claim 11, further comprising a bottom panel positioned between the heat exchanger and the gas burner.

15. The oven of claim 14, wherein the bottom panel includes a rear opening through which there is fluid communication between the gas burner and the heat exchanger.

16. The oven of claim 11, wherein the heat exchanger comprises a plurality of vertically extending tubes, wherein said combustion products will flow upward through the vertically extending tubes.

17. The oven of claim 16, wherein the heat exchanger further comprises a plurality of openings, wherein each of the plurality of openings is positioned between adjacent ones of said vertically extending tubes.

18. The oven of claim 16, wherein the heat exchanger further comprises a plurality of elongated openings extending between a front face and a rear face thereof.

19. The oven of claim 11, wherein the gas burner includes a plurality of flame ports, the flame ports being positioned under an inlet port of the heat exchanger such that the flame ports are physically isolated from turbulent airflow from the fan.

20. The oven of claim 11, wherein the heat exchanger comprises an inlet port position at a bottom portion of the oven cavity and an outlet portion positioned at a top portion of the oven cavity, and wherein a width of the heat exchanger is greater than a width of the fan.
